(19) United States
(12) Patent Application Publication
(10) Pub. No.: US 2024/0247527 A1
(43) Pub. Date: Jul. 25, 2024

(54) SLIDING DOOR TRACK WITH SOFT CLOSE

(71) Applicant: ASSA ABLOY Access and Egress Hardware Group, Inc., New Haven, CT (US)

(72) Inventor: Daniel Picard, Watertown, CT (US)

(73) Assignee: ASSA ABLOY Access and Egress Hardware Group, Inc., New Haven, CT (US)

(21) Appl. No.: 18/411,492

(22) Filed: Jan. 12, 2024

Related U.S. Application Data
(60) Provisional application No. 63/440,291, filed on Jan. 20, 2023.

(51) Int. Cl. E05F 5/00; E05F 15/41; E05F 15/42; E05F 15/641; F03G 3/08; F03G 7/00

(52) U.S. Cl. CPC E05F 5/003; E05F 15/41; E05F 15/42; E05F 15/641; F03G 3/08; F03G 7/0252

(57) ABSTRACT

A sliding door closure system is provided including close and energy harvesting to recover kinetic energy from the motion of the door. According to some embodiments, the relative motion between a sliding door and sliding door track may be configured to drive a generator. The generator may be driven by a driving a wheel rotationally connected to the generator. Examples include driving the generator by a friction wheel, by a chain and sprocket, or by a gear and rack. The generator may recover kinetic energy from the motion of the door during the deceleration of the soft close function. Energy recovered from the door may be stored and used to assist the motion of the door or to operate sensors to monitor the operation of the door closure system. The door closure system may transmit data and preserve a record of use.

### CROSS-REFERENCE TO RELATED APPLICATIONS

This application claims the benefit under 35 U.S.C. § 119(e) to U.S. Provisional Application Ser. No. 63/440,291, entitled “SLIDING DOOR TRACK WITH SOFT CLOSE” and filed Jan. 20, 2023, which is herein incorporated by reference in its entirety.

### FIELD

The present disclosure relates sliding door tracks with soft close, energy harvesting, and related methods of use.

### BACKGROUND

Sliding doors may be employed in a variety of residential, commercial, and industrial settings. In some cases, a sliding door may be supported from a track by one or more trolleys that allow the door to slide between an open position and closed position. In some instances, mechanical soft close mechanisms are employed to slow the door as it nears an end of travel near the open position or closed position.

### SUMMARY

In some aspects, the techniques described herein relate to a sliding door closure system for a door configured to slidably cover a door opening, the sliding door closure system including: a track configured to be located adjacent to the door opening and further configured to slidably support the door, a drive wheel configured to rotate in response to a relative motion between the door and the track, a generator operatively connected to the drive wheel, the generator configured to convert a portion of kinetic energy of the door to electric energy, and an energy source configured to receive the electric energy produced by the generator and store the electric energy.

In some aspects, the techniques described herein relate to a sliding door closure system including: a track, a plurality of trolleys configured to mount to a door and to slidably support the door on the track, an electrical generator including a stator and a rotor and configured to generate electrical energy when there is a relative motion between the plurality of trolleys and the track, where rotation of the rotor generates the electrical energy, at least one sensor configured to collect data on operation of the door, and an energy source configured to receive and store the electrical energy from the electrical generator, where the energy source is configured to supply power to the at least one sensor.

In some aspects, the techniques described herein relate to a method for operating a sliding door, including: sliding a door along a track from a first position to second position, converting a translational motion of the door to a rotational motion of a drive wheel, converting kinetic energy from the door to electrical energy by driving a rotor of a generator with the rotational motion of the drive wheel, and storing the electrical energy in an energy source.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a side view of a sliding door including a door closure system with energy harvesting in an open position;

FIG. 1B is a side view of a sliding door including a door closure system with energy harvesting in a partially open position;

FIG. 1C is a side view of a sliding door including a door closure system with energy harvesting in a closed position;

FIG. 2 is a side view of another embodiment of sliding door including a door closure system with energy harvesting;

FIG. 3 is a perspective view of an energy harvesting generator according to some embodiments;

FIG. 4 is perspective view of an energy harvesting generator according to other embodiments;

FIG. 5 is a schematic of one embodiment of an energy harvesting door closure system;

FIG. 6 is a schematic of another embodiment of an energy harvesting door closure system;

FIG. 7 is a schematic of aspects of an energy harvesting door closure system;

FIG. 8 is a side view of a sliding door including a door closure system with obstacle sensing;

FIG. 9 is a diagram of a method for recovering kinetic energy with a door closure system; and

FIG. 10 is a diagram of a method for operating a door closure system.

### DETAILED DESCRIPTION

In some cases, conventional sliding doors may use mechanical soft close assemblies. Mechanical soft close assemblies may store mechanical energy, such as in the form of a pressurized fluid such as a gas and/or oil, springs, or similar methods. For example, mechanical soft close assemblies may employ a pressurized damper cylinder used to slow a sliding door near an extent of the door's travel (e.g., adjacent an open or closed position of the sliding door). Additionally, in many cases, mechanical soft close assemblies may not be adjusted properly and may be abused which may result in doors being difficult to operate or failing prematurely. Mechanical soft close assemblies may not be able to detect such failures and alert a user for maintenance. In some other cases, conventional sliding doors may employ an electric actuator. Such electric actuators may require hardwired electrical connections that may not be available or are otherwise difficult to install in all desired installation locations. Full electronic actuation may not be desirable due to cost and/or complexity or user preferences.

In view of the above, the inventors have recognized and appreciated the benefits associated with methods and systems including door closure systems incorporating a soft close, energy harvesting, and smart operation. According to some embodiments, a door soft close may recover and store some energy from the motion of the door. Energy recovery may regulate the motion of the door such as by slowing the door near the extents of its travel (e.g., as the door approaches one of an open position or a closed position). The door closure system may additionally use the stored energy to further regulate the motion of the door and to power an electric striker. Such an arrangement may allow a sliding door to be easier to use and to be partially electrified without a dedicated power source (e.g., hardwiring).

The inventors have also appreciated the benefits of a sliding door closure system that includes sensors and a controller. According to some embodiments, the sensors may collect, store and/or transmit information from the use of the door to affect the operation of the door to monitor usage patterns and/or to detect faults in door operation. Such an arrangement may improve operation of the sliding door and provide enhanced management and service (e.g., maintenance) of a sliding door closure system.

A sliding door closure system may include hardware configured to slidably join a door to a door opening. In some embodiments, a door closure system may include a track and one or more door trolleys that may slidably connect a door to the track. An electric striker may be included, such as to electrically latch/unlatch the door. An energy harvesting system may be part of a door closure system. The energy harvesting system may include an energy harvesting generator such as those embodiments described later in this disclosure. A door closure system may additionally include at least one sensor and a controller. A soft close may be included in a door closure system. The soft close may be a functionally built into the energy harvesting system and/or the electric striker. Some embodiments of a door closure system may include additional components, as this disclosure is not so limiting.

Sliding doors are used in a variety of commercial, residential, and institutional applications. A sliding door includes one or more panels configured to translate substantially laterally relative to a door opening to cover and uncover the door opening. According to some embodiments, sliding doors operate on one or more tracks, which may be located at the top of the door. A trolley may ride on the track and thereby allow the door to translate. In some embodiments, additional tracks or wheels may be present on the bottom of the door. In some embodiments, a sliding door may close against a door opening, such as against a door jamb or door stop. In some embodiment, a sliding door may close against another door. As used herein a “closed position” refers to the door being in the position that most fully covers a door opening and where the door may be latched, locked, or otherwise secured as appropriate to the installation to remain closed. As used herein, an “open position” refers to the position of a door where a door opening is least blocked by the door (e.g., where the door opening is fully uncovered or uncovered as much as allowed by the door travel) and where the door is at the normal extent of its open travel such that any devices present to hold the door open may receive or secure the door open.

A sliding door may be used in interior or exterior applications. In some cases, sliding doors may have a weight within a range of 125-500 lb. Embodiments of such sliding doors may be found in commercial, industrial, and institutional settings. Examples include hospitals, warehouses, factories, schools, municipal facilities, and others. Doors may serve as fire doors, doors to potentially hazardous environments including freezers ovens etc., or doors to block radiation on such as x-rays or for other purposes. In some applications, sliding doors may be used in large door openings such as to allow the passage of vehicles or equipment. This disclosure is not to be limiting to the type of door or application.

As used herein, energy harvesting refers to the conversion and recovery of energy associated with movement of a door where the harvested energy may be applied to serve a useful purpose. In some cases, energy may be said to be harvested if that energy originated as kinetic energy in the door and has been captured such as to be stored electrical energy. In some embodiments, energy obtained through energy recovery may be expended such as for the purpose of activating or configuring energy recovery hardware. In such a scenario, the difference between the energy captured as output and the energy expended to produce the energy output would be the energy harvested. In some embodiments, harvesting kinetic energy may serve to slow the motion of the door, such as to slow the door during a soft close operation. Energy harvesting may include the selective recovery of energy associated with a deceleration of a door during portions of its operation. According to some embodiments, energy harvesting may be performed by an electrical generator. In some embodiments, energy harvesting may enable a soft close (e.g., prolonged deceleration of the door near the extent of its travel) or a power assist (e.g., producing a force to reduce the effort to slide a door and/or acceleration of the door from a stationary position). In some embodiments, energy harvesting may be independent from soft close functionality. In some such embodiments, soft close functionality may be provided as part of a separate electric striker mechanism. In some embodiments, harvested energy may be stored in an energy source such as a battery, or capacitor for later use by one or more components of a door closure system.

Electrical generators as described in this disclosure represent rotating electrical generators where the rotation of a generator shaft will induce an electric current within the generator while simultaneously producing a resistive force which opposes the rotation of the generator shaft. Without wishing to be bound by theory, the resistive force and electrical energy produced are generally proportional to each other and increase with an increase in rotational speed of the generator. The generator shaft is rigidly coupled to a rotor that spins within the generator. A stator surrounds the rotor and does not spin. Magnets are disposed within one of the stator and the rotor. Wire coils are disposed within the other of the stator and rotor. Rotation of the rotor induces an electric current within at least some of the coils to generate electric energy. Furthermore, electrical generators of the type described differ from electric motors only in the direction of the electrical current, that is electrical energy may be applied to a generator as an electric current which would result in the generator exerting a force on the generator shaft and rotating the shaft (if not constrained) while consuming electrical energy. The direction of the force and rotation depends on how the electrical energy is applied. A generator may therefore exert a resistive force to a moving door while generating electrical energy and may additionally be used to apply a force that is either resistive or assistive to the motion of the door when the generator is operating as a net consumer of electrical energy.

A door soft close is a mechanism configured to slow the motion of a closing door near the point of closure for the purpose of slowing the door to a stop. A soft close may be employed to a door to give a gentle close, to avoid slamming or noise, or to avoid hard contact between a closing door and a user. According to some embodiments, a soft close may present a closing force that increases with position to smoothly bring a door to rest. In other embodiments a soft close may be controlled to achieve certain door velocities at certain positions along a door track A soft close as used herein may describe a device which controls the motion of a door at least near the extent of its travel by the conversion of kinetic energy to electrical energy or by the conversion of electrical energy to mechanical work or to kinetic energy. Conversion should not be interpreted to be an attempt to recover energy in all aspects. According to some embodiments, a soft close may intentionally dissipate energy, such as by back driving an electric motor to operate as a brake. If operating to recover kinetic energy, excess energy may be dissipated if an energy source (e.g., battery) is fully charged. It should be appreciated that an electric soft close will have an efficiency and some energy may be lost, such as to heat, in the process of conversion even if the soft close is configured to recover the kinetic energy of door. In some embodiments, the conversion between kinetic and electric energy may include intermediate steps such as gravitational potential or elastic energy. In some embodiments, a soft close may be used as part of an electric door actuator or may be used on otherwise manually operated doors. In some embodiments, a soft close may be part of an electric striker mechanism. In some embodiments, an electric striker mechanism may automatically latch a door left slightly ajar. An electric soft close may be independent of the operation of a door latch/door lock or its operation may be integrated with the operation of a latch/lock (e.g., including an electric striker), as this disclosure is not so limiting.

According to some embodiments, a sliding door closure system may additionally serve as an assist, such as to push a closed door open when a user activates a door handle, knob, or latch. In other embodiments, the door closure system may provide energy to move a door that may be left ajar such as to pull the door into the open position or the closed position. In some embodiments, the power assist may relieve a user of some physical demands of sliding the door and/or serve as a brake if a user pulls back to resist the motion of a door. According to some embodiments, a door closure system may provide variable resistance to the motion of a door. For instance, a door closure system may brake and slow a door that is being operated above a threshold speed. In some embodiments, a door closure system may deactivate energy harvesting if a door is being moved too slowly. The door closure system may establish a speed limit for the door, which may take the form of a maximum door speed or target door speed range. The target speeds/speed ranges may vary for different portions the track. For instance, a maximum/target speed may decrease near either end of the track. Speed limits may be provided as a safety feature, such as to maintain a door at a speed where obstacle strikes may be prevented, or as a protective feature for the door, such as to limit operation that may result in excessive wear or damage. A user or door installer may be able to set speeds for a specific application and in other cases global limits may exist for a certain hardware design.

Aspects of the soft close, energy harvesting, and the power assist may be performed separately or together and any combination of the embodiments described may be present or omitted in a particular door closure system. The soft close, energy harvesting, and power assist may be incorporated within the same mechanism, such as with an electric generator or may be accomplished by separate devices such as with a separate electric soft close, or any combination thereof, as this disclosure is not so limiting.

Energy to perform any of the functions of the soft close or energy harvesting may be withdrawn from an energy source. In some embodiments, an energy source may be configured to supply power to at least one sensor of a door closure system. The stored electrical energy within the energy source may have originated from the harvesting of kinetic energy of the moving door. The energy source may include one or more batteries, capacitors, or other storage media. A battery may include any method of electro-chemical storage of electrical energy regardless of chemistry or trade name. Some embodiments may use lead acid batteries, nickel-cadmium batteries, nickel metal hydride batteries, lithium-ion batteries, lithium-ion polymer batteries or other battery chemistries. In some embodiments, the energy source may be disposed within the sliding components of the door closure system, on the door itself, or in a stationary position such as on the door opening side.

According to some embodiments, the door closure system may include condition monitoring to control operation of the door, detect use patterns, detect abuse, and/or enhance maintenance of a sliding door. In some embodiments, a door closure system may include sensors such as accelerometers; encoders and position sensors; force sensors; latch position sensors; temperature sensors (such as for fire or controlled environment); smoke detectors (to detect fire); microphones; cameras; proximity sensors; battery voltage monitors; current monitors (detect stuck door, worn equipment etc.); or other sensors. Such sensors may obtain information that is employed in condition monitoring. In some cases, the information obtained by a sensor may be provided to a local processor (e.g., onboard the door closure system) or a remote processor (e.g., a server). In some embodiments, condition monitoring may include sensing if a person or obstacle may by in the way of the sliding door (e.g., the obstacle is in a doorway). In some embodiments, condition monitoring may improve a user experience, such as by learning and anticipating use patterns which may be used to adjust force/speed limits for the door. Condition monitoring may also detect failures of the door closure system and communicate failures to maintenance personnel and preserve a record of use and/or abuse of the door. In some embodiments, one or more force sensors may detect a force required to slide the door. The force required to slide the door may be indicative of wear in the door closure system. The door closure system may monitor the evolution of the force required to slide the door to monitor the wear or overall condition of the door closure system. The door closure system may notify a user, such as maintenance personnel, if the force required to slide the door or a trend in the force required to slide the door indicates wear, failure, or impending failure. For example, a message may be transmitted (e.g., a text message, email, push notification, or other digital communication) to a user to communicate the particular failure. Failure may be indicated by hitting a certain required force threshold or due to a pattern in force measurements indicating that the mechanism is outside of some specification or tolerance. Failure may mean that a door closure system is unacceptably worn or has reached a certain point in its service life. Failure does not necessarily mean that the door closure system is incapable of operating or that a sudden event (e.g., a fracture, impact, loss of electrical power etc.) has occurred to bring about the failed condition, and the present disclosure is not so limited in this regard.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

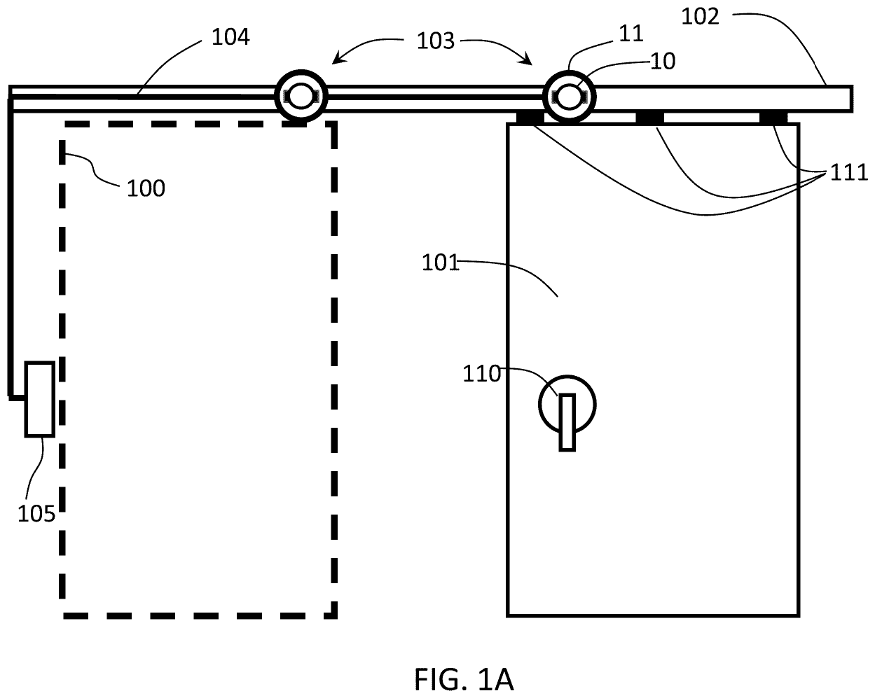

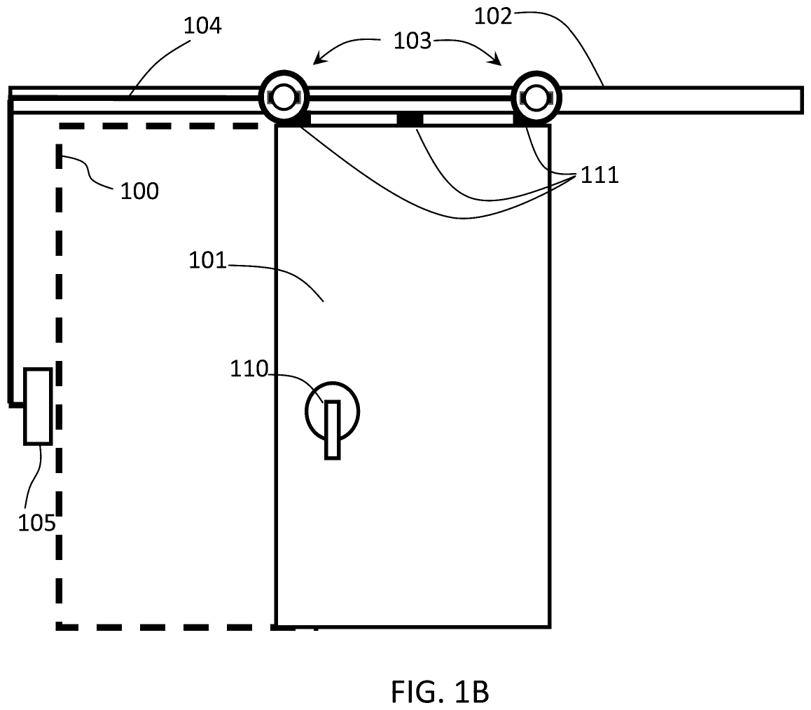

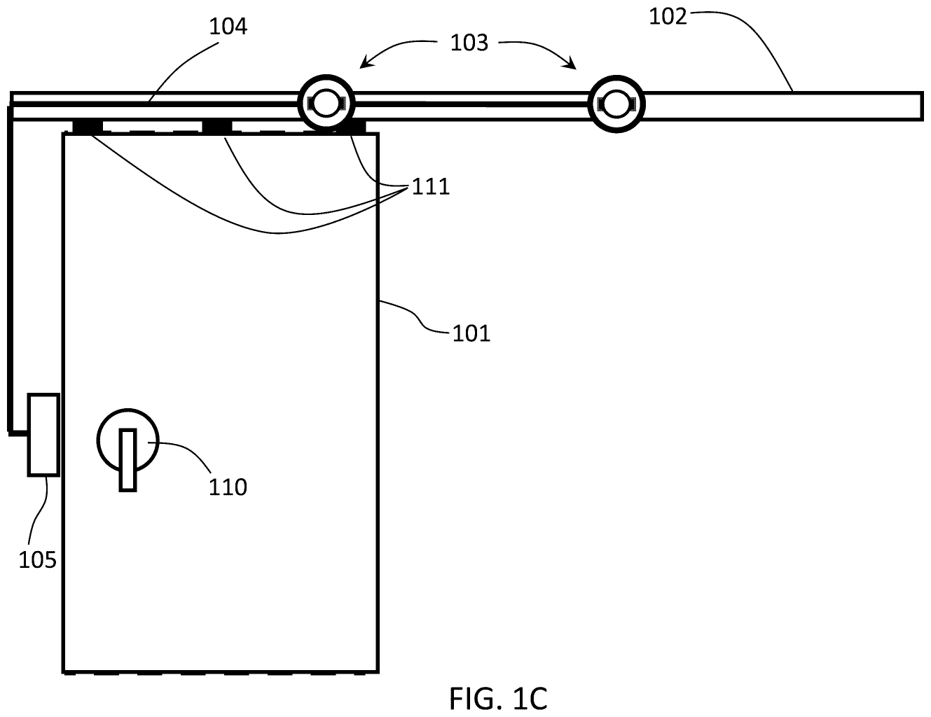

FIG. 1A. depicts one embodiment of a sliding door including an energy harvesting door closure system with the sliding door in a fully open position. A door opening 100 in a wall may be selectively covered by a door 101 (illustrated open). The door 101 slides along a track 102 above and to the right as illustrated (relative to the page) of the door opening allowing the door to slide between an open position and a closed position. The door 101 is supported by trolleys 111 which slidably engage with the track 102 and allow the door to translate in a horizontal direction. The trolleys 111 may additionally include wheels, rollers, or bearings (not shown), which may ride within the track 102 in the form of a “C” or “U” channel which may obscure and protect the wheels, rollers or bearings. The vertical faces of a “C” or “U” channel track may be termed leaves.

A handle 110 is provided for the user to grab and slide the door, and may additionally include a lever, knob, or other tactile control which a user may engage such as to release the door from the door opening 100. An electric striker mechanism 105 disposed within the door opening 100 may engage a latch, striker, hook, and/or deadbolt to secure the door in a closed position. At least one energy harvesting generator 103 is affixed at a location stationary relative to the door opening and configured to contact a portion of door 101 and to be driven by movement of the door. According to the illustrated embodiment, two energy harvesting generators are shown in stationary positions attached to the door opening. Each energy harvesting generator 103 includes a generator 10 rotationally coupled to a drive wheel 11 that may be a friction contact wheel as illustrated. A drive wheel 11 of one or both energy harvesting generators 103 may contact an upper surface of the door 101. Relative motion of the door 101 with respect to the drive wheel 11 may cause the drive wheel to rotate, turning generator 10 which may convert a portion of the kinetic energy of the door 101 to electrical energy and imparting a resisting force that opposes the motion of the door 101. While friction driven energy harvesting generators 103 are illustrated on the stationary portion of the door closure system, other embodiments are contemplated, including any number of energy harvesting generators including those located within the door 101 and mechanically driven embodiments. As used herein, the term “drive wheel” may include wheels driven by friction/traction or mechanically, such as sprockets, sheaves, gears etc. that may be used to drive a generator. Wiring 104 may connect one or more energy harvesting generators with energy storage and/or other equipment. According to some embodiments, wiring 104 may be run along an internal leaf the door track such as to provide power to an electric strike within the door frame of the door opening 100.

As shown in FIG. 1A, the door closure system may include a controller 121, a processor 122, and memory 123 including computer readable non-transitory storage. According to some embodiments, the controller 121 may establish the speed and location of the door using the processor 122 included therein, the processor may determine speed and position by interpreting an output of a position sensor. The controller 121 may additionally configure the energy harvesting system, such as to harvest or not harvest energy under a given condition and also to administer soft close and power assist functions. The controller 121 may preserve a record of door operation in non-transitory memory 123. Memory 123 may be accessed by the controller and/or by a user such as a service technician. It should be appreciated that components need not be of the size, shape, number, or position indicated in the figure and various embodiments will be discussed further below. For instance, in some embodiments at least one controller may be located on the door itself.

FIG. 1B depicts the door of FIG. 1A at middle position along the track. The door 101 may be in an opening position (e.g., moving toward an open position) or closing position (e.g., moving toward a closed position) as illustrated. The door partially obscures the right side of the door opening 100. FIG. 1C shows the door and closure of FIGS. 1A and 1B with the door in the fully closed position. The electric striker mechanism 105 may latch door 101 in the closed position. An upper track is illustrated however in some embodiments additional tracks may be used. According to the embodiment of FIG. 1B, the door is disposed outside of the door opening 100. In some other embodiments, the door may also be enclosed within a wall in the open position, such as a pocket door. In other embodiments, multiple door panels may ride on separate parallel tracks which may overlay each other in an open position.

In some embodiments, a door closure system may include clutches or mechanical overrides to reduce the likelihood of a door jamming in a position, especially a closed position, in the event of a failure or loss of power. For example, a clutch or override may disengage an energy harvesting generator 103 to avoid resistive force being applied to the door 101. Additionally, in some embodiments, the door may be designed to maintain operation in a fire and to remain able to be opened if the mechanism is damaged. In some embodiments, doors may additionally be provided with an automatic closure in case of fire such as a fusible link, magnetic hold open, angled track/gravity close, or other arrangement.

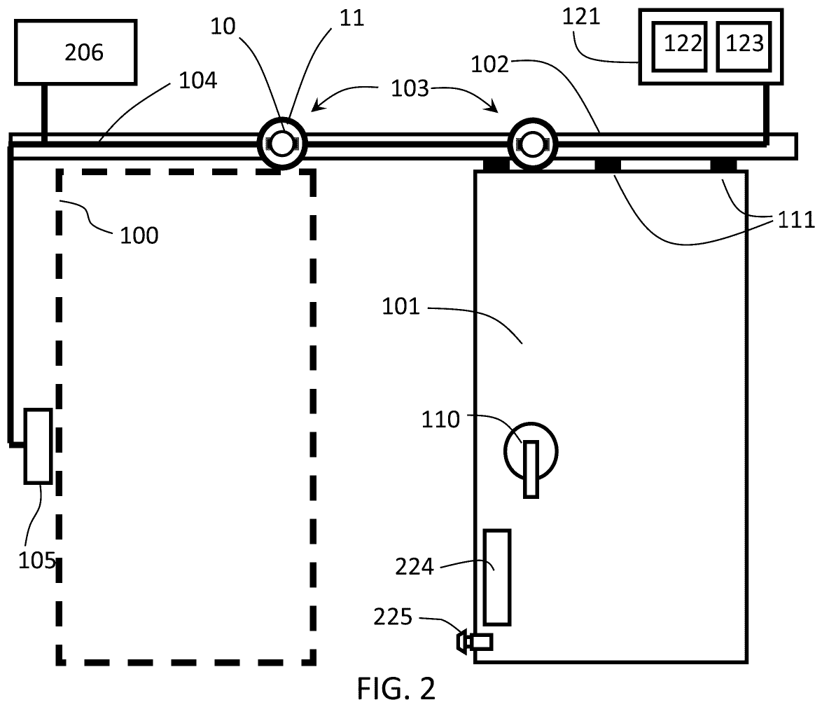

FIG. 2 depicts an embodiment of a sliding door closure system including energy harvesting generators 103. A door 101 slides along the track 102 to slidably cover the door opening 100. The electric striker mechanism 105 is located on the door opening 100 such as within a door frame. Energy harvesting generators 103 are located on the stationary portion of the door closure system attached to the door opening. Each energy harvesting generator 103 includes a generator 10 and drive wheel 11 in the form of a friction wheel configured to drive the generator by traction between the drive wheel 11 and a portion of the door 101. Multiple energy harvesting generators may be used, and a door may be in contact with a specific energy harvesting generator for a portion of its travel. At some positions along a track, a door may be in contact with multiple energy harvesting generators. In some embodiments at other positions the door may be out of contact with all energy harvesting generators. The number and position of the generators may be used to modulate the sliding resistance of the door on certain portions of the track, such as to add more resistance near an open position or a closed position and thereby slow the door as it reaches an extent of its travel.

Electrical energy produced by the energy harvesting generator(s) 103 may be carried by wires 104 to an energy source 206 and/or electric striker mechanism 105. Wires 104 may include any number of conductors, which may carry different voltages or current types (AC/DC). The energy source 206 may include one or more batteries, capacitors, or other storage media. Electrical energy from the energy harvesting generator(s) may trickle charge the energy source 206 such as batteries included therein. Power conditioning circuitry which may include rectifiers and/or signal conditioners may be included within the energy source 206. The energy source 206 may be disposed on the stationary portion of the door closure system, such as on or near the door opening as in FIG. 2, or it may be disposed on the door in some embodiments. Electrical energy may be withdrawn from the energy source 206 and used to power aspects of an energy harvesting generator, soft close, electric striker mechanism, electric locks, sensors, controllers, or for other purposes. The electrical energy source 206 may additionally include an AC/DC inverter, diode, transformer, and/or other power conditioning circuitry. As with previously described embodiments, the controller 121 may include the processor 122, and memory 123 in the form of computer readable non-transitory storage. The controller 121 may be located on the stationary side of the door closure system such as on the track 102 in some embodiments. In other embodiments, the controller may be located on or within the door, trolley, or other translating portion of the door closure system.

In some embodiments, sensors 224 may be provided on the door, such as proximity sensors to sense objects that may interfere with the operation of the door. Sensors 224 may further include position encoders, infrared sensors, thermocouples, radar, lidar, break-beam sensors, motion detectors, capacitive sensors, cameras, accelerometers, force or contact sensors. In some embodiments, position encoders may be used to establish a location of the door 101, the controller 121 may calculate the speed of the door from the time rate of change of position. In some embodiments, infrared sensors, radar, lidar, break-beam sensors, motion detectors, capacitive sensors, and cameras may be used to identify obstacles in a path of the door 101. In some embodiments, accelerometers, force, and contact sensors may be used to activate power assist, to monitor and/or control energy harvesting, identify wear to the door closure system, or to stop the door. Some or all sensors may be disposed in locations other than those pictured in the exemplary embodiment of FIG. 2. In some embodiments as shown in FIG. 2, an emergency stop 225 may be provided in the form of a stop bar or stop switch/button (as illustrated) to activate the soft close and/or brake the door 101 in the presence of an object.

According to some embodiments, a generator such as the generator 10 in the energy harvesting generator 103 may be a permanent magnet generator or a wound pole generator. The wound poles within a wound pole generator are electromagnets. The poles may be variably excited so as to control the output of the generator and therefore the resistive force that the energy harvesting generator will apply when extracting kinetic energy from a door. The excitation current may be provided by the energy source (e.g., a battery). The generator may produce direct current, DC, or alternating current, AC. According to some embodiments, a generator may be operable as a motor such as by providing current. A generator operating as a net user of electrical power to produce a force on the door may be termed a motor, such as to use the generator as an actuator for moving a door, or for using the generator as a brake. When operated as a brake, the energy harvesting generator 103 may produce a greater resistive force on the door 101 than may be produced by the energy harvesting generator when operating so as to harvest energy. The type of generator used may be independent of the method of driving the generator and other ways of connecting the generator will be disclosed below.

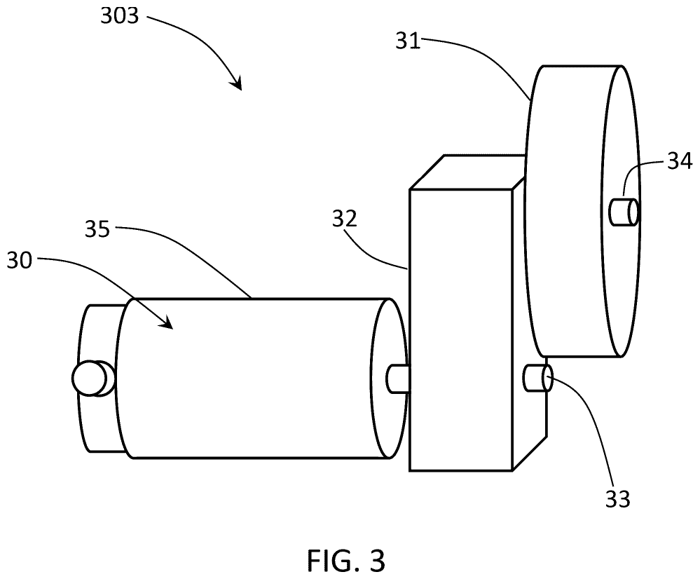

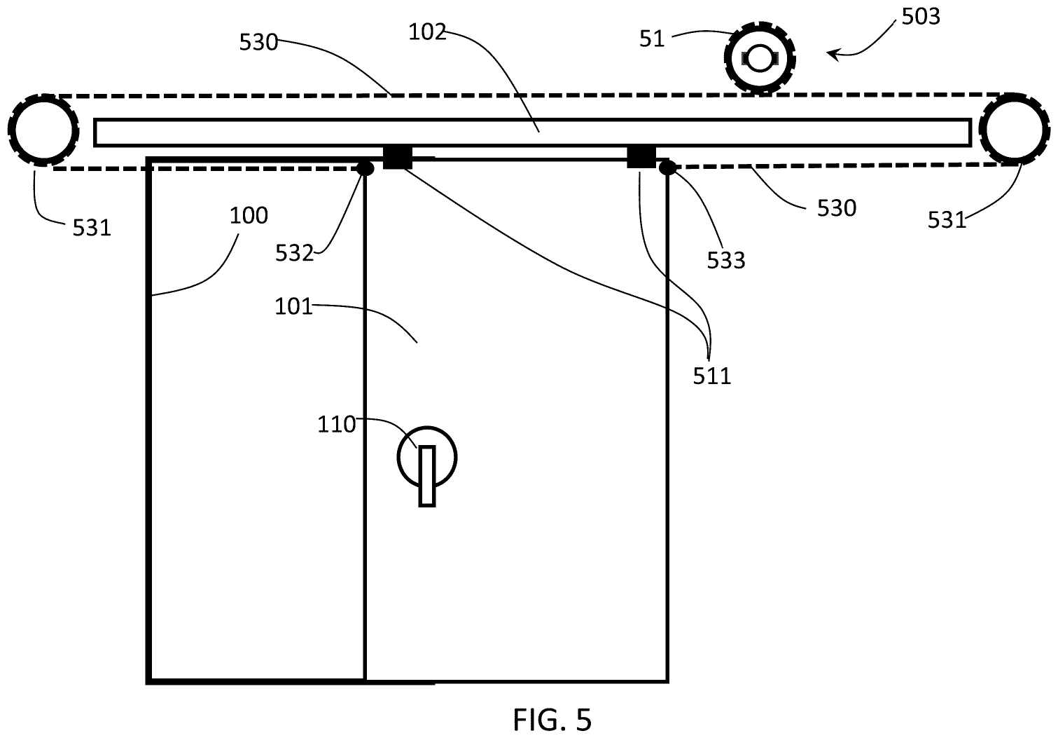

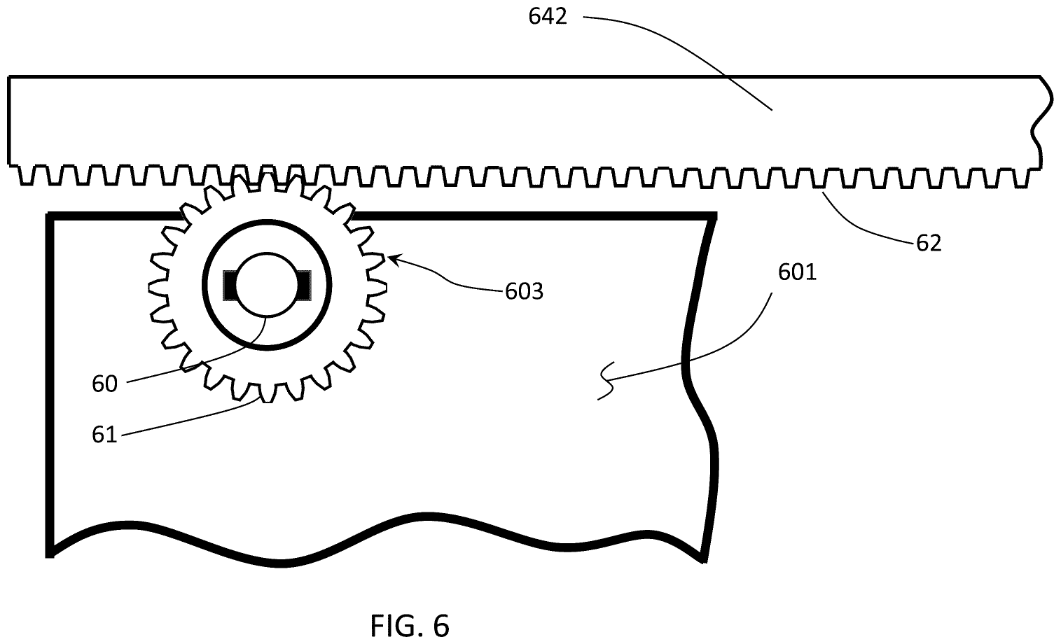

FIG. 3 shows one embodiment of an electric energy harvesting generator 303. The illustrated embodiment may be applied to sliding portions of the door closure system or to the door itself or may be applied to the track, door opening or other stationary position. An electric generator 30 is rotationally coupled to a drive wheel 31 through a gearbox 32. The drive wheel 31 may be rotated by friction/traction with some portion of the door or with a stationary object such as the track. In some embodiments the drive wheel may be mechanically engaged such as with a chain or rack, for example, as discussed further with reference to the embodiments of FIGS. 5-6. A drive wheel shaft 34 rotates with the drive wheel 31. The gearbox 32 may be provided such as to convert the rotational speed of the drive wheel 31 and drive wheel shaft 34 to a rotational speed more suitable for energy recovery in the electric generator 30. A generator shaft 33 is rotationally coupled to the electric generator 30. The gearbox may be a separate component as illustrated by the gearbox 32 in FIG. 3, or it may be located within an electric generator or within a drive wheel. According to some embodiments, the gearbox may be a planetary gearbox. In other embodiments the gearbox may be omitted such that the drive wheel may directly drive the electric generator 30. The generator shaft 33 is rigidly coupled to the generator rotor (not visible inside the generator). The generator stator is disposed on the interior facing portion of a generator frame 35, between the generator frame and the rotor. According to some embodiments, magnets included within one of the stator or the rotor may be electromagnets as previously discussed. The electromagnets may be energized by electrical energy withdrawn from the energy source to excite the poles of the electromagnets. The electrical output and resistive force produced by the generator may be adjusted by adjusting the energization of the electromagnets (i.e., the excitation of the poles). Bracketry to support the generator and gearbox and to connect both with a door or door opening is omitted for clarity in FIG. 3.

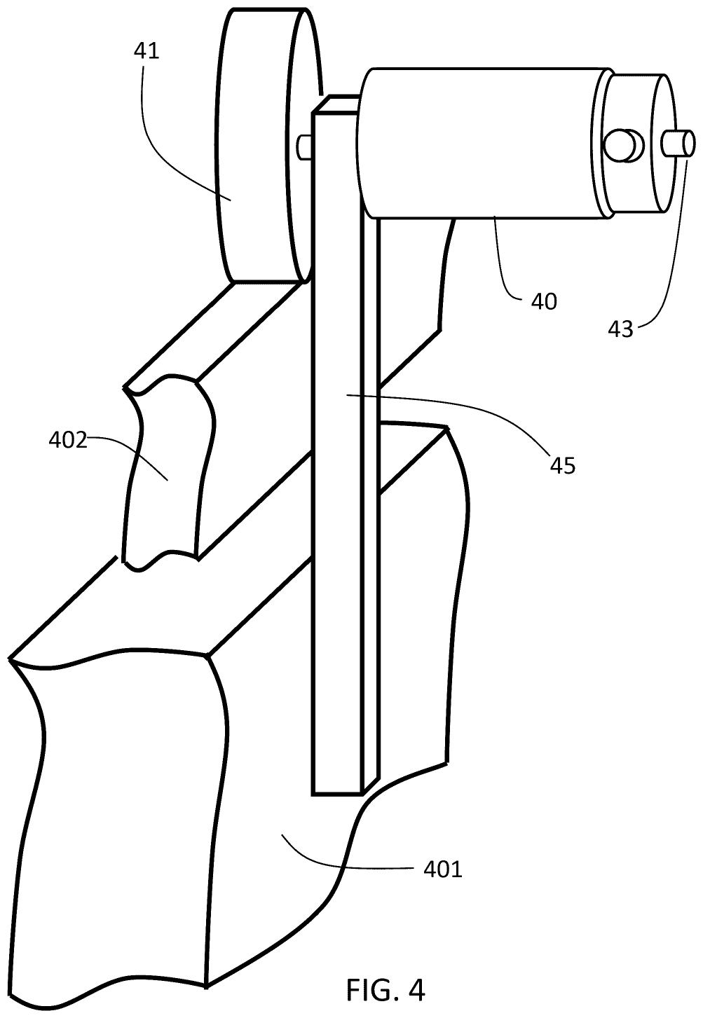

FIG. 4 shows an embodiment of an energy harvesting generator 40 as applied to a trolley configured mount to on a door 401 and slide therewith. In this embodiment, a drive wheel 41 is a friction drive wheel configured to run on a track 402. A portion of the weight of the door 401 is carried by a support 45 and transmitted to the friction drive wheel 41 such that the weight of the door 401 provides a normal force to support the traction of the friction drive wheel 41 with the track 402. A separate gearbox may be included such as illustrated in FIG. 3 to rotationally connect the friction drive wheel 41 with a generator armature shaft 43. The track 402 is depicted as a rectangular bar although other embodiments may include tracks with other cross sections, including tracks where the friction drive wheel 41 may be configured to ride inside a track such as track with a “C” or “U” channel cross section. The shape of the friction drive wheel 41 is also for example only and other shapes are contemplated such as shapes to better fit with the cross section of the track used. In some embodiments the generator may be geared such that generator armature shaft may be perpendicular to the axis of rotation of the drive wheel. The embodiment illustrated in FIG. 4 may reduce a need for a separate drive wheel tensioner in friction drive applications. For instance, a trolley incorporating an energy harvesting generator such as illustrated in FIG. 4 may be incorporated onto a door also including one non-energy harvesting trolley. In such an arrangement, approximately half of the weight of the door may be applied to the friction drive wheel 41 to provide a normal force to provide the friction drive wheel with traction to rotate the friction drive wheel when the door translates along the track.

FIG. 5 shows another embodiment of a sliding door including a chain driven electric energy harvesting generator. As with previously disclosed embodiments, the door 101 is slidably supported by the track 102 to selectively cover door opening 100. Trolleys 511 may additionally include wheels, rollers, or bearings (not shown), which may ride within a track 102. In the present embodiment, a chain 530 is fastened at both ends of the chain to the door 101 at chain connections 532 and 533 such that a continuous length of chain extends between the chain connection 532 and the chain connection 533. The length of chain passes over a sprocket 531 located at each end of the track 102. Sliding the door 101 along the track 102 will cause the chain 530 to move, rotating each sprocket 531. An energy harvesting generator 503 may be driven by the chain 530. A drive wheel 51 of energy harvesting generator 503 may be a sprocket configured to engage with the chain 530. In some embodiments, the energy harvesting generator may be incorporated with one of sprockets 531 such as to reduce the number of chain sprockets. A chain tensioner may be included with an energy harvesting generator or one or more sprockets 531, such as to provide a uniform tension in the chain 530. The chain 530 may be roller chain or any other suitable type of chain. According to other embodiments a belt, band, rope, or cable may be used as the chain. In the illustrated embodiment, the chain lies on a plane parallel to a face of the door, however, other arrangements are contemplated including embodiments where the chain lies in a plane substantially normal to a face of the door. In some embodiments, the chain 530 may be integrated into the track 102. In some embodiments, the chain may be attached to the trolleys 511 rather than the door.

FIG. 6 shows an embodiment of a sliding door including a gear driven energy harvesting generator. A rack 642 includes gear teeth 62. The energy harvesting generator 603 includes drive wheel 61 in the form of a gear engaged with rack 642. Translation of the gear drive wheel 61 along the longitudinal axis of rack 642 may impart rotation to the gear drive wheel 61. Gear drive wheel 61 is rotationally connected to a generator 60. A gearbox may optionally be provided between the gear drive wheel 61 and the generator 60. As illustrated, the energy harvesting generator 603 including the gear drive wheel 61 may be mounted on a door 601. The rack 642 may be mounted to the stationary door opening and may be attached to or formed integral with the door track (not shown). Other embodiments are contemplated where the rack may be attached to the door and the energy harvesting generator including a gear drive wheel may be attached to a stationary location such as a door opening or a door track. This disclosure is not limiting to the locations of the rack and energy harvesting generator. Multiple gear driven energy harvesting generators are also contemplated. In the illustrated embodiment, the gear drive wheel has an axis of rotation perpendicular to a face of the door however other embodiments are contemplated including embodiments where the gear drive wheel has an axis of rotation substantially parallel to a face of the door.

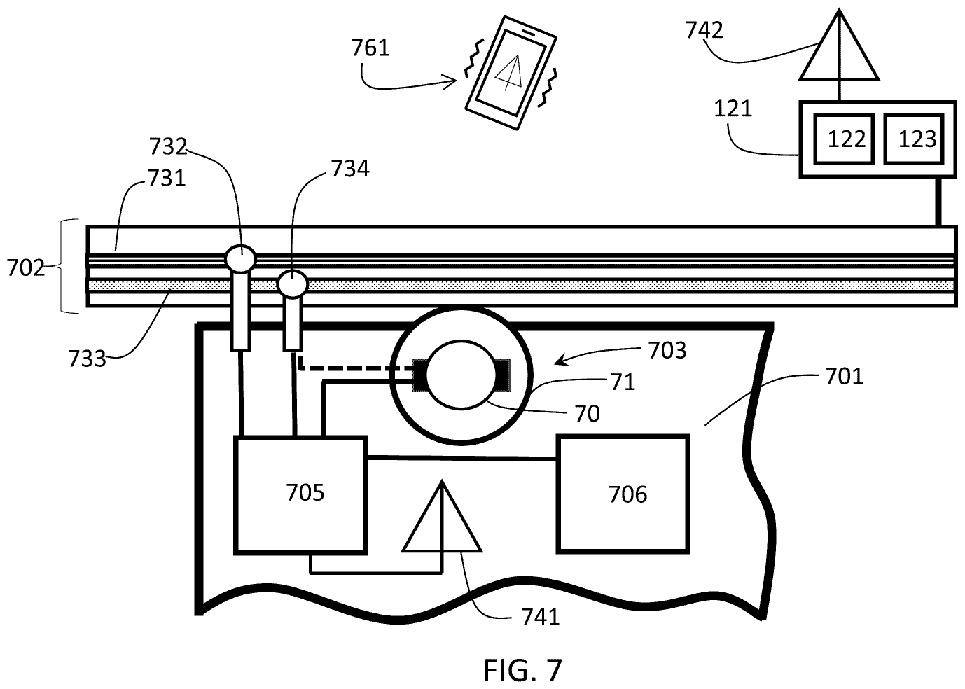

FIG. 7 depicts aspects of a door closure system including communication and electrical connections according to some embodiments. A door 701 is slidably supported by a track 702 incorporating energy recovery such as by frictional contact between an energy harvesting generator 703 and a track 702. As shown, energy harvesting generator 703 is consistent with door-mounted, traction driven embodiments such as that shown in FIG. 4, however it should be understood that other arrangements, including chain and geared embodiments of FIGS. 5 and 6 are contemplated. As shown in FIG. 7, the energy harvesting generator 703 includes a drive wheel 71 coupled to a rotor 70. An encoder path 731 and encoder pickup 732 which may read position along the encoder path may be provided to establish the location of the door/trolley along the track 702. One or more brushes 734 and brush paths 733 may be provided for slidable electrical connection between stationary elements of the door track and moving elements including the door and trolley. Brushes may be used to transmit recovered energy between stationary and sliding elements of the door closure system, or to communicate signals between the sliding and stationary elements such as may originate from one or more sensors. The brushes 734 may be carbon brushes, metallic brushes, or any other suitable material. The brush path 733 may be of any electrically conductive material and may additionally include non-conductive separating regions, such as to configure different operations in different portions of the track. An electronics module 705 may include power conditioning/rectifier circuits, sensing, control, and communications circuits and may be a controller of the door closure system. The electronics module 705 may be electrically connected to an energy source 706, the energy harvesting generator 703, the encoder pickup 732 and/or at least one brush 734.

As shown in FIG. 2, a door closure system may include a controller 121, a processor 122, and memory 123 including computer readable non-transitory storage. The processor 122 may be included within the controller 121 and may interpret outputs from sensors such as the sensors 224 illustrated in FIG. 2. The controller 121 may use the interpreted sensor outputs to direct the operation of the door closure system, such as to activate or deactivate energy harvesting or control the speed of the door etc. For instance, in some embodiments, the controller 121 may adjust the energy harvesting system by controlling the energization of electromagnets within a stator of the generator to control the resistive force and electrical energy produced by the generator. Usage data, sensor data, maintenance data and other information may be preserved in memory 123. Memory may be accessed by a user such as a service technician and may be accessed remotely. Data may also be used to improve a user's experience such as by anticipating usage patterns or identifying faults, wear, or other defects. For instance, the door closure system may include a force sensor and may preserve a record of measurements of the force necessary to slide the door. The controller 121 may then compare current measurements of the force required to move the door to historical measurements of the force required to move the door such as to identify trends that may be indicative of wear or other maintenance problems. The door closure system may report data, including to send status reports for maintenance or to report misuse of the door. Data may be transmitted from the door over a wired or wireless network, and/or downloaded or recalled from memory such as during maintenance.

According to some embodiments, signals including real-time location data signals such as from the encoder pickup 732 may be communicated wirelessly. A stationary antenna 742 may be included in electrical connection with the controller 121. The stationary antenna 742 may communicate wirelessly with a door mounted antenna 741 in electrical connection with the electronics module 705 affixed to the door. This may permit communication between the moving and stationary portions of the door closure system without requiring such communication to use a brush and brush path. The stationary antenna 742 and/or the door mounted antenna 741, or any other antenna, may communicate wirelessly with a user device, such as a phone 761 provided for example. User devices may also to include tablets, computers, wireless networks, etc. The door closure system may additionally communicate with a building security or alarm system by wired or wireless connection.

The energy source 706 may include one or more batteries, capacitors, or other storage media configured to receive harvested energy and to provide energy to be withdrawn such as to power sensors, controller 121, a soft close, an energy harvesting system or other purposes. A battery may include any method of electro-chemical storage of electrical energy regardless of chemistry or trade name. Some embodiments may use lead acid batteries, nickel-cadmium batteries, nickel metal hydride batteries, lithium-ion batteries, lithium-ion polymer batteries or other battery chemistries. Electrical energy may be provided to the energy source 706 from the energy harvesting system. The electrical energy may be conditioned before being stored. Conditioning may include changing voltage/current, or phase of the electrical energy and/or converting AC electric energy to DC electric energy. Conditioning may occur anywhere in the door closure system such as in the electronics module 705, within the enclosure of the energy source 706 or other convenient location.

Not all electrical connections or components illustrated in FIG. 7 may be present in all embodiments and FIG. 7 does not include all elements contemplated. Components illustrated in FIG. 7 may be used separately, combined together, omitted, or used in numbers or combinations different from those illustrated in the figure, as the present disclosure is not so limiting.

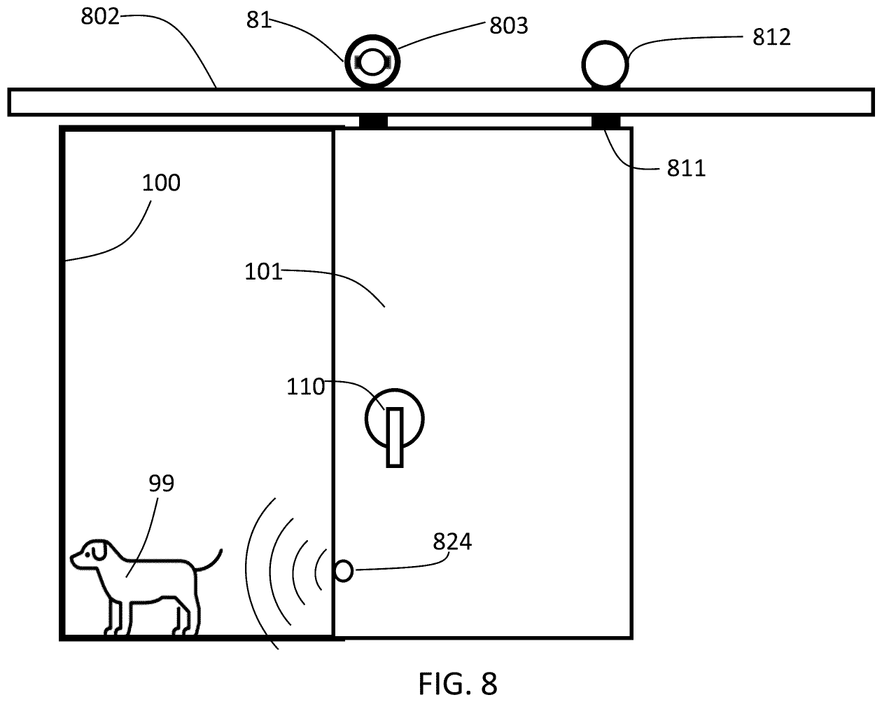

FIG. 8 shows a sliding door closing with an obstacle, such as dog 99, in the door opening 100. In some embodiments, as discussed previously, it may be desirable to change an operation of a door closure system based on the detection of an obstacle. In some embodiments, obstacles may include any object (e.g., package, furniture, vehicle, etc.), person, or animal. The obstacle (e.g., the dog 99) is detected by a proximity sensor 824 which may be one of sensors 224 illustrated in FIG. 2. A signal from proximity sensor 824 be provided to the controller (such as controller 121 of FIGS. 1A-1C, 2 and 7) which may interpret the sensor signal to indicate the presence of an obstacle, causing the door closure system to brake the motion of the door, such as may be done by harvesting the kinetic energy of the door, back driving a motor, or applying an optional friction brake. The proximity sensor may include a break beam sensor, motion sensor, camera, or other sensor or combination of sensors such as those described previously in this disclosure. In some such embodiments, when the obstacle is removed the door may slide freely.

The embodiment illustrated in FIG. 8 also shows an example of a door including energy harvesting generator 803 with a friction drive wheel located within a trolley where the weight of door 101 provides a normal force on the friction drive wheel 81 to provide traction between the friction drive wheel 81 and the door track 802 and additionally slidably supporting the door 101 at a first location. A bracket 811 supports a (non-energy harvesting) roller wheel 812 slidably supporting the door 101 on track 802 at a second location. According to some embodiments, additional brackets and roller wheels may be used, however the single roller wheel 812 and single trolley mounted energy harvesting generator 803 may be preferred in some cases, such as by allowing a static equilibrium of the weight of the door to provide a substantially consistent normal load on friction drive wheel 81 independent of adjustment of the bracket 811 and the roller wheel 812. It should be appreciated that the obstacle sensing aspects illustrated in FIG. 8 are not specific to the friction drive embodiment and may be applied to any embodiment of the energy harvesting generator including all other embodiments described herein.

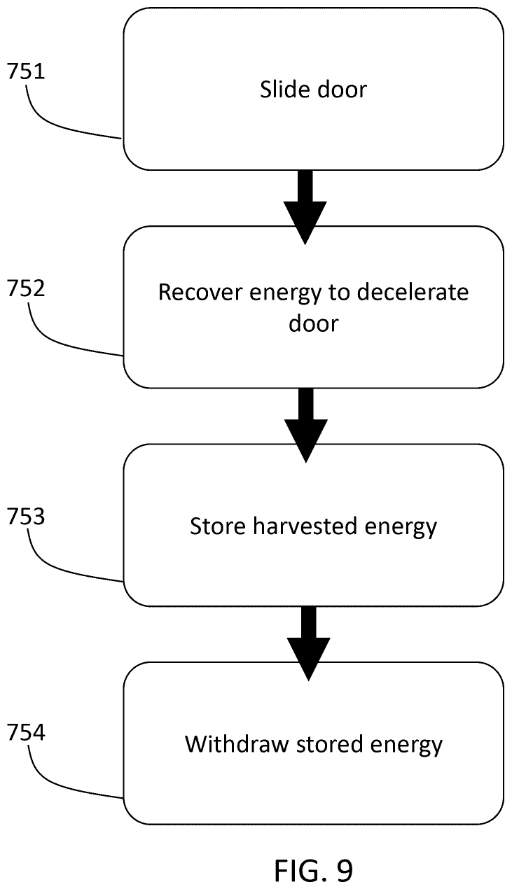

An exemplary method for operating a sliding door is illustrated in FIG. 9. The method includes a user sliding a door in block 751, such as sliding the door along a track from a first position to second position. Energy is harvested by recovering some kinetic energy decelerating the door in block 752. According to some embodiments, energy is harvested by converting a translational motion of the door to a rotational motion of a drive wheel and then by converting kinetic energy from the door to electrical energy by driving a rotor of a generator with the rotational motion of the drive wheel. The harvested electrical energy is stored in block 753 in an energy source such as in one or more batteries or capacitors. The stored energy is withdrawn in block 754 as electrical energy, such as by pulling electrical current from a battery. The electrical energy may be used for processes associated with the door closure system or for any other purpose. Examples include withdrawing stored energy to power one or more sensors and/or controllers and/or to transmit information. In some embodiments, the withdrawn electrical energy is applied to the generator to produce a force resisting the sliding motion of the door, for instance to energize electromagnets in the energy harvesting generator or to operate the energy harvesting system as a motor or brake. In some embodiments this may include withdrawing stored energy to operate the soft close, for instance slowing the sliding motion of the door with the force resisting the sliding motion of the door. In other embodiments, an electric striker and/or a soft close may be separate to the energy harvesting system; separate soft close mechanisms may also be powered by energy withdrawn from the energy source.

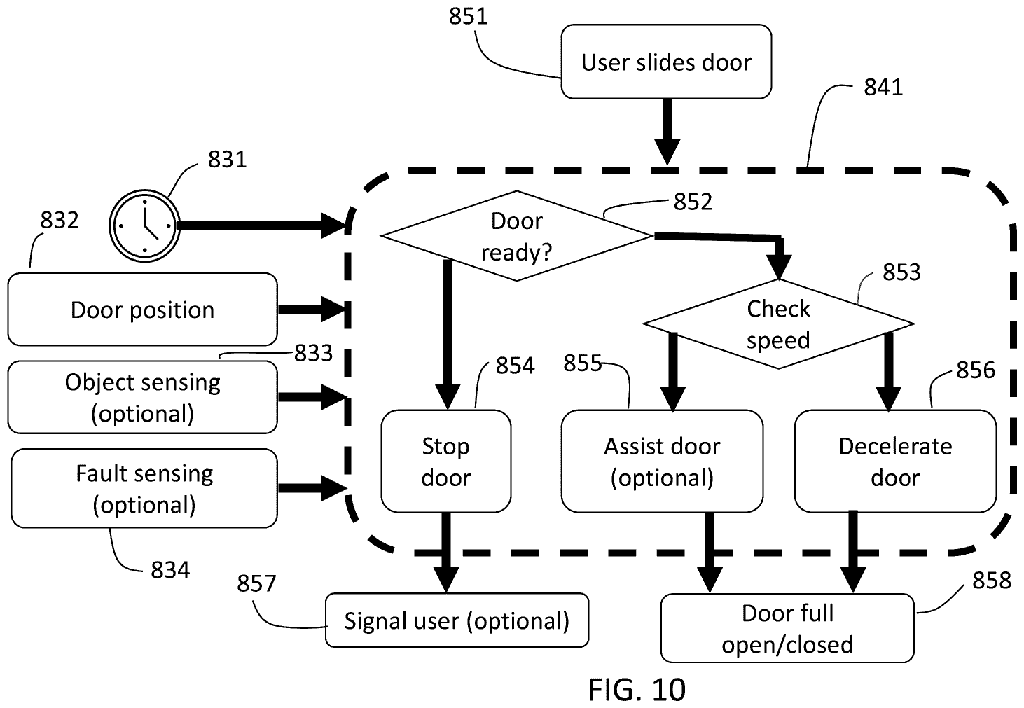

Another exemplary method for regulating the motion of a sliding door according to some embodiments is provided in the block diagram of FIG. 10. A user slides a door in block 851 to operate the door. The door sensing loop of block 841 receives inputs. The time signal block 831 may be a local/global time signal or it may be a processor clock. Processor clock signals may originate from within the processor/controller and need not come from a source external to the door closure system. Door position is measured in block 832 by one or more sensors, such as for instance by the encoder illustrated in FIG. 7, although other sensing methods are also contemplated (e.g., potentiometers, proximity sensors, break-beam sensors, capacitive sensors, rotary encoders in embodiments with gears or sprockets, etc.). Door position from block 832 along with time signal from block 831 may allow the calculation instantaneous velocity so that the door's speed may be known at any position along the track. Object sensing signals 833 may include signals from one or more proximity sensors, motion detectors, radar, lidar, break-beam sensors, or other sensors to determine if the path of the door is clear of obstructions. Fault sensing block 834 includes sensing of faults or anticipated faults within the door closure system or external to the door closure system. Internal faults may be insufficient electrical power, erroneous sensor readings, indications of failure of a linear generator/motor, excessive load, or other failure. External faults may include fires or other building emergencies. Faults may be communicated to the door closure system by wired or wireless communication, such signals need not originate from sensors included within door closure system and may additionally arise from fire alarm switches or alarm/panic buttons.

Within door sensing block 841, one or more controllers decides if a door is ready to move in block 852. “Ready” in this context means at least that the door is reported in condition to operate, and the motion path detected to be clear of obstacles if object sensing capability is present. Additional considerations may be included, examples may include lock signals, door handle position, building alarms, user credential checks etc. If the door is not found to be ready, the door closure system may apply a brake (or otherwise apply resistive force to a door with a motor generator) to stop the door in block 854 and optionally signal the user in block 857, such as including by an alarm or message to a phone, device, or security station. Braking may be performed by an energy harvesting generator in some embodiments. The controller may exit door sensing block 841 until the user attempts to slide the door again, presumably after the resolution of the fault or obstacle. If the door is determined to be ready, the one or more controllers checks door speed in block 853 which may include calculating speed from time and position data. Door speed may be compared against a door speed target or speed limit which may be a function of door/trolley position along the track. If the door is found to exceed a speed target or speed limit, the controller may decelerate the door to maintain the desired speed in block 856. Deceleration may include deceleration by energy harvesting by recovering kinetic energy from the door. The door may trigger deceleration in any portion of the track, including within the free sliding region if the door may be determined to be sliding at an excessive speed. Sensing loops continue until the door reaches the fully open or closed position in block 858 exiting the loop.

If the door speed check, block 853 finds the door to be at or below a target speed no action may be taken in some embodiments. Energy harvesting may only occur above some threshold speed to make the door easier to push at low speeds. In other embodiments, optionally, the door closure system may assist the user in operating the door in block 855, such as by a power assist to aid the user in moving the door. The power assist may be delivered by the components otherwise responsible for energy harvesting and/or soft close functionality, and may utilize recovered energy to power the assist mechanism. For example, an assistive force applied in a direction of motion of the door may be applied by a generator. The assist mechanism may be to operate the energy harvesting generator as a drive motor. Again, when a final position is achieved the control exits door sensing block 841 with the door in the open or closed position block 858. In the closed position, the door may be latched closed by an electric striker mechanism.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A sliding door closure system for a door configured to slidably cover a door opening, the sliding door closure system comprising:
a track configured to be located adjacent to the door opening and further configured to slidably support the door;
a drive wheel configured to rotate in response to a relative motion between the door and the track;
a generator operatively connected to the drive wheel, the generator configured to convert a portion of kinetic energy of the door to electric energy; and
an energy source configured to receive the electric energy produced by the generator and store the electric energy.

2. The sliding door closure system of claim 1, wherein the door closure system has an open position where the door is open and a closed position where the door is closed and wherein the generator is further configured to slow a motion of the door as the door approaches at least one of the open position or the closed position.

3. The sliding door closure system of claim 2, wherein the generator is a first generator, wherein the first generator is configured to slow the motion of the door as the door approaches the closed position, and further comprising a second generator, wherein the second generator is configured to slow the motion of the door as the door approaches the open position.

4. The sliding door closure system of claim 1, wherein the drive wheel is a friction drive wheel.

5. The sliding door closure system of claim 4, wherein the friction drive wheel is configured to be engaged with the track, and wherein the friction drive wheel is further configured to support at least a portion of a weight of the door.

6. The sliding door closure system of claim 1, further comprising a chain configured to be attached to the door, wherein the drive wheel is a sprocket engaged with the chain, and wherein the sprocket is configured to rotate in response to a movement of the chain.

7. The sliding door closure system of claim 1, further comprising a rack attached to the track, wherein the drive wheel is a gear engaged with the rack and is configured to rotate in response to a movement of the door.

8. The sliding door closure system of claim 1, wherein the generator is mounted to the door such that the generator is configured to move with the door.

9. The sliding door closure system of claim 1, wherein the generator is mounted to a position that remains stationary relative to the door opening and the track.

10. The sliding door closure system of claim 1, wherein a gearbox is operatively connected between the drive wheel and the generator.

11. A sliding door closure system comprising:
a track;
a plurality of trolleys configured to mount to a door and to slidably support the door on the track;
an electrical generator comprising a stator and a rotor and configured to generate electrical energy when there is a relative motion between the plurality of trolleys and the track, wherein rotation of the rotor generates the electrical energy;
at least one sensor configured to collect data on operation of the door; and
an energy source configured to receive and store the electrical energy from the electrical generator, wherein the energy source is configured to supply power to the at least one sensor.

12. The sliding door closure system of claim 11, wherein the at least one sensor is a position sensor configured to measure a position of the door on the track.

13. The sliding door closure system of claim 11, wherein the at least one sensor is a force sensor configured to measure a sliding resistance of the door.

14. The sliding door closure system of claim 11, further comprising a processor configured to interpret an output from the at least one sensor, wherein the processor is configured to direct the operation of the door closure system based at least in part on the output interpreted from the at least one sensor.

15. The sliding door closure system of claim 14, further comprising a non-transitory memory, wherein the processor is configured to record the output of one or more sensors in the non-transitory memory.

16. The sliding door closure system of claim 14, wherein the processor is additionally configured to collect and transmit data regarding at least one of the operation or condition of the sliding door closure system.

17. The sliding door closure system of claim 11, wherein the at least one sensor is configured to detect a presence of an obstacle in a path of the door.

18. The sliding door closure system of claim 14, wherein the door closure system has an open position where the door is open and a closed position where the door is closed and wherein the processor uses the output from the at least one sensor to operate the electrical generator to slow the door as the door approaches at least one of the open position or the closed position.

19. The sliding door closure system of claim 11, additionally comprising an electric striker mechanism configured to latch the door in a closed position, and wherein the electric striker mechanism is configured to be powered by electric energy from the energy source.

20. A method for operating a sliding door, comprising:
sliding a door along a track from a first position to second position;
converting a translational motion of the door to a rotational motion of a drive wheel;
converting kinetic energy from the door to electrical energy by driving a rotor of a generator with the rotational motion of the drive wheel; and
storing the electrical energy in an energy source.

21. The method of claim 20, further comprising slowing the translational motion of the door by extracting the kinetic energy from the door.

22. The method of claim 20, further comprising powering at least one sensor with the electrical energy withdrawn from the energy source.

23. The method of claim 20, further comprising:
withdrawing electrical energy from the energy source;
applying the withdrawn electrical energy to the generator to produce a force resisting the translational motion of the door; and
slowing the translational motion of the door with the force resisting the translational motion of the door.

24. The method of claim 22, further comprising:
detecting an object in a path of the door using the at least one sensor; and
slowing the translational motion of the door upon detecting the object.

25. The method of claim 22, further comprising sensing a position of the door along the track.

26. The method of claim 22, further comprising:
measuring a force used to slide the door with a force sensor;
identifying a failure in the sliding door based on the measured force exceeding a force threshold; and
notifying a user if the failure is identified.
